(19) United States
(12) Patent Application Publication
(10) Pub. No.: US 2024/0054834 A1
(43) Pub. Date: Feb. 15, 2024

(54) INFORMATION PROCESSING DEVICE, INFORMATION PROCESSING SYSTEM, AND PASSAGE MANAGEMENT METHOD

(71) Applicant: Panasonic Intellectual Property Management Co., Ltd., Osaka (JP)

(72) Inventor: Masao KUBOTA, Tokyo (JP)

(73) Assignee: Panasonic Intellectual Property Management Co., Ltd., Osaka (JP)

(21) Appl. No.: 18/265,394

(22) PCT Filed: Nov. 25, 2021
(86) PCT No.: PCT/JP2021/043171

§ 371 Date: Jun. 5, 2023

(30) Foreign Application Priority Data
Dec. 7, 2020 (JP) 2020-202624

(51) Int. Cl. G07C 9/10; G07C 9/37

(52) U.S. Cl. CPC G07C 9/10; G07C 9/37

(57) ABSTRACT

This information processing device includes: a tracking unit that tracks a subject to be authenticated who is heading from a first region toward a second region into which entry is permitted in accordance with a result of authentication processing, even before the subject to be authenticated moves to the first region; an authentication unit that performs authentication processing on the subject to be authenticated, located in the first region; and a processing unit that, when the movement of the subject to be authenticated to the first region is detected by the tracking unit, associates the result of the authentication processing on the subject to be authenticated with the result of tracking the subject to be authenticated, and tracks the subject to be authenticated, and thereby manages entry of the subject to be authenticated into the second region.

### TECHNICAL FIELD

The present disclosure relates to an information processing apparatus, an information processing system, and a passage-through management method.

### BACKGROUND ART

A technique of managing entry and exit of a person passing through agate installed in a station, an airport, or the like is known. Patent Literature (hereinafter referred to as “PTL”) 1 describes an apparatus that tracks whether a person has passed through a gate (or has returned to entrance of gate), based on a change in position of a wireless card, in a situation where the person proceeds into the gate from the entrance of the gate with permission for passage through the gate obtained by the wireless card.

### CITATION LIST

### Patent Literature

PTL 1
Japanese Patent Application Laid-Open No. H09-330440

### SUMMARY OF INVENTION

It is desired to manage whether or not someone has passed through agate and which person has passed through the gate in gates where entry and exit are managed. In the following, this management may be abbreviated as “passage-through management” or “tracking management.” There is room for further study on improving the accuracy of the passage-through management.

One non-limiting and exemplary embodiment of the present disclosure facilitates providing an information processing apparatus, an information processing system, and a passage-through management method each capable of improving the accuracy of passage-through management for a target that is about to pass through a particular region.

An information processing apparatus according to an embodiment of the present disclosure includes: a tracker that tracks an authentication target heading from a first region to a second region into which entry is allowed in accordance with a result of authentication processing, the tracker being configured to start tracking the authentication target before the authentication target moves to the first region; an authenticator that performs the authentication processing on an authentication target situated in the first region; and a processor that manages entry of the authentication target into the second region by tracking the authentication target while associating a result of the authentication processing for the authentication target and a tracking result for the authentication target when the tracker detects that the authentication target has moved to the first region.

An information processing system according to an embodiment of the present disclosure includes: an authentication apparatus that performs authentication processing on an authentication target situated in a first region; and an information processing apparatus that includes a tracker and a processor, the tracker tracking the authentication target heading from a first region to a second region into which entry is allowed in accordance with a result of the authentication processing, the tracker being configured to start tracking the authentication target before the authentication target moves to the first region, the processor managing entry of the authentication target into the second region by tracking the authentication target while associating a result of the authentication processing for the authentication target and a tracking result for the authentication target when the tracker detects that the authentication target has moved to the first region.

A passage-through management method according to an embodiment of the present disclosure includes: tracking, by an information processing apparatus, an authentication target heading from a first region to a second region into which entry is allowed in accordance with a result of authentication processing, the tracker being configured to start tracking the authentication target before the authentication target moves to the first region; performing, by the information processing apparatus, the authentication processing on an authentication target situated in the first region; and managing, by the information processing apparatus, entry of the authentication target into the second region by tracking the authentication target while associating a result of the authentication processing for the authentication target and a tracking result for the authentication target when it is detected that the authentication target has moved to the first region.

It should be noted that general or specific embodiments may be implemented as a system, a method, an integrated circuit, a computer program, a storage medium, or any selective combination thereof.

According to a non-limiting and exemplary embodiment of the present disclosure, it is possible to improve the accuracy of passage-through management for a target that is about to pass through a particular region.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1A illustrates an example of a configuration concept of a passage-through management system according to one embodiment;

FIG. 1B illustrates a configuration example of the passage-through management system according to the embodiment;

FIG. 2 illustrates exemplary zones specified for a gate;

FIG. 3 illustrates Variation 1 of the zones specified for the gate;

FIG. 4 illustrates Variation 2 of the zones specified for the gate;

FIG. 5 is a flowchart for indicating exemplary control flows in passage-through management system 1 according to the embodiment;

FIG. 6 illustrates an exemplary tracking-management table;

FIG. 7 illustrates definition examples of event IDs;

FIG. 8 illustrates a first example of a person-tracking event;

FIG. 9 illustrates a list of candidates for event IDs of a person who has proceeded into from the south side;

FIG. 10 illustrates a list of candidates for event IDs of a person who has proceeded into from the north side;

FIG. 11 illustrates an example of Use Case 1;

FIG. 12 illustrates an example of Use Case 2;

FIG. 13 illustrates an example of Use Case 3;

FIG. 14 illustrates an example of Use Case 4;

FIG. 15 illustrates an example of Use Case 5;

FIG. 16 illustrates an example of Use Case 6;

FIG. 17 illustrates an example of Use Case 7;

FIG. 18 illustrates an example of Use Case 8;

FIG. 19 illustrates an example of Use Case 9;

FIG. 20 illustrates an example of Use Case 10; and

FIG. 21 illustrates an example of Use Case 11.

### DESCRIPTION OF EMBODIMENTS

Hereinafter, preferred embodiments of the present disclosure will be described in detail with reference to the appended drawings. Note that, in the present specification and drawings, components having substantially the same functions are provided with the same reference symbols, and redundant description will be omitted.

### One Embodiment

<Findings Leading to Present Disclosure>

In a gate installed in a facility such as a station and an airport to manage entry and exit to the facility, it has been studied to utilize passage-through management that accurately manages which person has passed through the gate and whether the person has correctly passed through the gate. Under an insufficient passage-through management, for example, a person who has entered from an entrance of the gate but turned back to the entrance of the gate instead of heading to an exit of the gate may be erroneously judged as having passed through, or a person who has actually passed through may be erroneously recognized as not having passed through. Such errors might lead to erroneous charging of fares, particularly in a situation where fees are charged to those who have passed through a gate, such as a station ticket gate.

In order to execute the passage-through management, for example, authentication processing of authenticating a person who is about to pass through (including processing of determining that authentication is unable) and tracking processing of recording a history of movement of the person are performed. It is desirable that the processing be performed at an early stage in order to ensure the time for recording passage-through of a person, performing processing of regulating movement of a person such as opening/closing processing of a gate door, and the like.

In the technique described in PTL 1, the passage-through management is executed by using a wireless card capable of transmitting an ID. That is, the authentication processing is performed by an ID transmitted from the wireless card, and the tracking processing is performed by checking a change in position of the wireless card. Here, communication using the wireless card can be performed at a high speed, and thus, in PTL 1, the passage-through management is executed with a configuration that checks an ID and then tracks the position of the wireless card having the ID.

Matching using face images (or authentication, hereinafter sometimes referred to as “face authentication”) may take longer time than authentication using a wireless card. Therefore, a start of the passage-through management is delayed in a configuration in which, after the authentication processing is completed, the tracking processing is performed in association with the authentication processing. Consequently, the tracking result may be partially lost, which may cause an inaccurate passage-through management.

Thus, anon-limiting and exemplary embodiment of the present disclosure achieves improvement of the accuracy of the passage-through management by early starting passage-through management of a target which is about to pass through a particular region.

According to a non-limiting and exemplary embodiment of the present disclosure, processing for the passage-through management can be started early by tracking in advance a target passing through a particular region, and associating, upon entry into a first region, an authentication result and a tracking result of the target with each other, thereby preventing the tracking result from being lost, and improving the accuracy of tracking management.

Note that, in a typical passage-through management, since it is sufficient for an authentication result to be obtained until the timing immediately before a target passes through a particular region (e.g., timing for regulating movement or recording passer), a configuration in which the tracking of the target is started prior to associating with the authentication result, as in a non-limiting and exemplary embodiment of the present disclosure, is unlikely to cause inconvenience to the passage-through management.

<System Configuration>

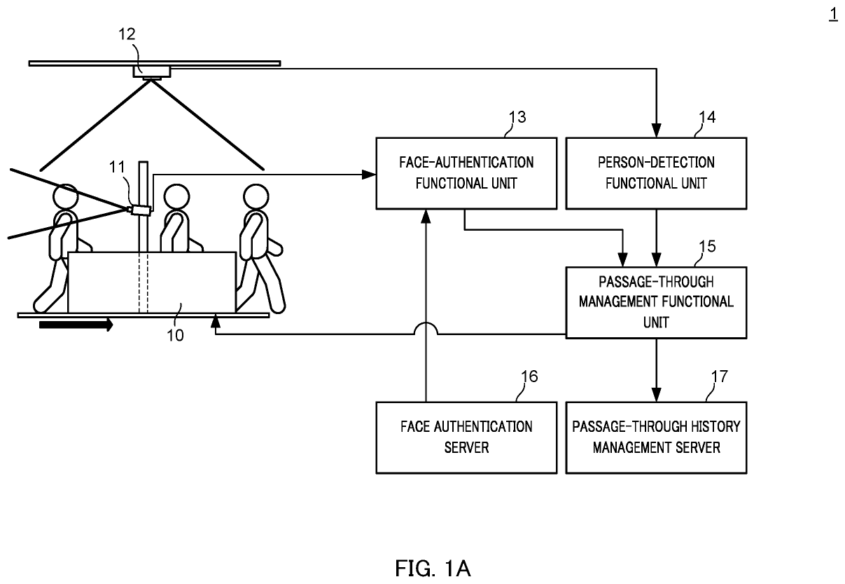

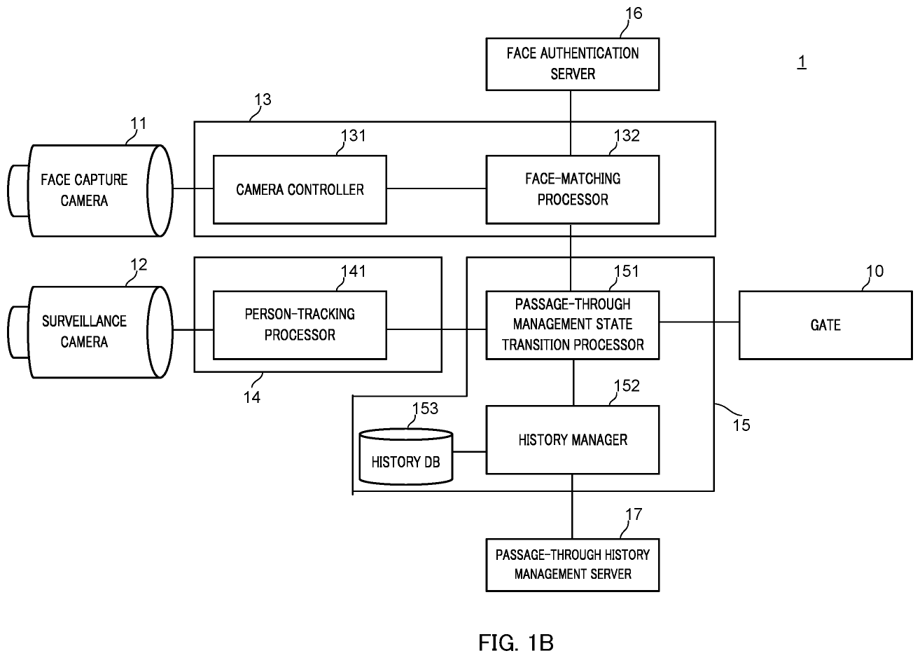

FIG. 1A illustrates an example of a configuration concept of a passage-through management system according to the present embodiment. FIG. 1B illustrates a configuration example of the passage-through management system according to the present embodiment Passage-through management system 1 according to the present embodiment is a system for managing passage of people through a gate (such as entering gate, ticket examination gate) installed in an entrance and/or exit (hereinafter referred to as an entrance/exit) of a facility such as an airport, a station, or an event venue.

Passage-through management system 1 according to the present embodiment is, for example, management of entry and exit on a user who uses a facility is executed by face authentication. For example, when the user enters the facility through a gate, it is judged by the face authentication whether the user is a person permitted to enter the facility. In addition, when the user exits the facility through the gate, it is judged by the face authentication whether the user is a person permitted to exit the facility. Note that the “face authentication” may be regarded as a concept included in “matching using a face image.”

Passage-through management system 1 includes gate apparatus (hereinafter sometimes abbreviated as “gate”) 10, face capture camera 11, surveillance camera 12, face-authentication functional unit 13, person-detection functional unit 14, passage-through management functional unit 15, face authentication server 16, and passage-through history management server 17. In passage-through management system 1, the number of gates 10 may be one or more.

Gate 10 is installed in, for example, a facility such as an airport, a station, or an event venue. A user permitted to use the facility passes through gate 10 when he/she enters the facility and/or exits the facility. Gate 10 also executes control to block passage-through of a person not permitted to enter the facility.

Face capture camera 11 is mounted to a support provided on gate 10, for example. The support may be, for example, a pole vertically extending from gate 10 or an arch-shaped member provided on gate 10. When there is a person who passes through gate 10 or a person who is attempting to pass through gate 10, face capture camera 11 captures a capturing region that includes the face of the person. For example, the capturing region of face capture camera 11 is an area where a frontal face of a person can be captured. Incidentally, when gate 10 is configured to allow bidirectional passage-through, two face capture cameras 11 that capture faces of persons passing through in the respective directions may be mounted. In the following, an image captured with face capture camera 11 may be referred to as a face-capture camera image. Note that the face-capture camera image may not include a face. Further, a plurality of face capture cameras 11 may be provided. In this case, a capturing direction and/or an angle of each face capture camera 11 may be made different to capture a face of a person in a wider range.

Surveillance camera 12 (may also be referred to as “person-tracking camera”) is mounted above gate 10, for example, and captures an area of gate 10 as viewed from above. The capturing region of surveillance camera 12 includes an entrance/exit of gate 10 when gate 10 is viewed from above. Note that the capturing region of surveillance camera 12 may include a plurality of gates 10. Further, a plurality of surveillance cameras 12 may capture one or a plurality of gates 10. In the following, an image captured with surveillance camera 12 may be referred to as a surveillance-camera image. For example, the surveillance-camera image is an image captured from a position and/or an angle different from those or that for the face-capture camera image.

Note that a camera provided for monitoring gate 10 and the facility including gate 10 by an administrator may be diverted for surveillance camera 12, or the surveillance camera may be installed for passage-through management system 1. For example, in a case where surveillance camera 12 is for monitoring by an administrator, an image (or moving image) captured by surveillance camera 12 may be recorded in a recording server (not illustrated in FIGS. 1A and 1B).

Meanwhile, surveillance camera 12 may capture gate 10 from laterally, or obliquely upward, or a plurality of cameras with different capturing directions and/or capturing ranges may be used. That is, any number of cameras and/or any position of a camera is possible as long as surveillance camera 12 is capable of capturing an area that includes an entrance/exit of gate 10.

Incidentally, although the above has given an example in which face capture camera 11 and surveillance camera 12 are different cameras, the present disclosure is not limited to this case. For example, an image captured with face capture camera 11 may be used in person-detection processing (or person-tracking processing) to be described later, or an image captured with surveillance camera 12 may be used in face-authentication processing to be described later. Also, for example, an image captured with one camera may be used in both of the person-detection processing and the face-authentication processing. Further, for example, an image captured with at least one of the plurality of face capture cameras 11 may be treated as a surveillance-camera image, or an image captured with at least one of the plurality of surveillance cameras 12 may be treated as a face-capture camera image.

Face-authentication functional unit 13 performs the face-authentication processing on a face-capture camera image. For example, face-authentication functional unit 13 has camera controller 131 and face-matching processor 132.

Camera controller 131 periodically performs initialization of face capture camera 11, for example. Camera controller 131 controls a capture timing of face capture camera 11. For example, face capture camera 11 performs capturing at a speed of about five fps (frame per second) under the control of camera controller 131. Camera controller 131 performs face-frame detection on the face-capture camera image captured by face capture camera 11. When a face frame is detected, camera controller 131 outputs information on the detected face frame (face-frame detection information) and the face-capture camera image to face-matching processor 132.

Face-matching processor 132 crops, based on the information on the face frame, a face region included in the face-capture camera image and indicates, to face authentication server 16, a face matching request including information on the cropped face region. The information on the face region may be an image of the face region or may be information indicating a feature point extracted from the image of the face region.

In face authentication server 16, face images of persons who are permitted to pass through gate 10 are registered, illustratively. The face images registered in face authentication server 16 may be each referred to as a registered face image. The registered face image may be associated with information such as an ID of the registered person. The registered face image may also be information indicating a feature point extracted from an image.

When receiving the face matching request from face-matching processor 132, face authentication server 16 judges whether the registered face images include a face of the same person as the face in the face region included in the face matching request. Face authentication server 16 indicates, to face-matching processor 132, a face matching result including a judgement result. Note that the face matching result may include information indicating whether the registered face images include the face of the same person as the face in the face region (e.g., flag indicating “OK” or “NG (Not Good, i.e., not included)”), and may include, when the registered face images include the face of the same person as the face in the face region, the ID or the like of the person associated with one of the registered face images.

The matching is to judge, by comparing the registered face images with a face image of a person who passes through gate 10, whether any of the registered face images matches the face image of the person who passes through gate 10, or whether any of the registered face images and the face image of the person who passes through the gate are face images of the same person.

Meanwhile, the authentication is to prove to the outside (e.g., to gate) that a person of a face image matching one of the face images registered in advance is the person herself/himself (i.e., person is a person who is permitted to pass through gate).

However, in the present disclosure, “matching” and “authentication” may be used as mutually interchangeable terms.

For example, matching processing is a process of comparing feature points of the registered face images registered in advance with a feature point extracted from the detected face region and thereby identifying who the face in the image data is. Specifically, e.g., a technique using machine learning is known, but the detailed description of which is omitted because it is a known technology. Further, the matching processing is described as being performed in face authentication server 16, but this processing may be performed in another device such as gate 10 or may be performed in a plurality of devices in a distributed manner.

Face-matching processor 132 outputs information including a matching processing result to passage-through management functional unit 15. Incidentally, the matching processing result may include information on the registered face images and a matching score indicating a degree of matching of the face images obtained by the matching processing. Further, the information output from face-matching processor 132 may include the face-frame detection information and a capturing time for the face-capture camera image in which the face frame has been detected.

Person-detection functional unit 14 performs the person-detection processing on a surveillance-camera image. Person-detection functional unit 14 includes, for example, person-tracking processor 141. The person-detection processing may be regarded as the person-tracking processing.

When a person is present in the surveillance-camera image, person-tracking processor 141 detects a position (range) of the person. Person-tracking processor 141 then judges an event for the detected person. Examples of events to be judged will be described later. Person-tracking processor 141 judges an event that is based on the position of the person and performs tracking of the person by associating the judged event with the position of the person, the detection time, and the like.

Person-tracking processor 141 outputs information on the person-tracking to passage-through management functional unit 15.

Passage-through management functional unit 15 manages states of persons around gate 10 by associating the information output from face-authentication functional unit 13 with the information output from person-detection functional unit 14. The persons around gate 10 include, for example, a person passing through gate 10, a person who is about to pass through the gate, and a person passing by the vicinity of gate 10. Here, the person who is about to pass through gate 10 is a person who is not permitted to pass through gate 10 but attempts to pass through the gate. Moreover, the person passing by the vicinity of gate 10 is, for example, a person who is not planned to pass through gate 10 but has passed through the capturing region(s) of face capture camera 11 and/or surveillance camera 12. Also, a state of a person includes, e.g., whether the person is moving or stationary, and a moving direction of the person when he/she is moving.

Passage-through management functional unit 15 has passage-through management state transition processor 151, history manager 152, and history data base (DB) 153.

In passage-through management processing for people, passage-through management state transition processor 151 transmits, to gate 10, control information on control of gate 10 when a person who is permitted to pass through gate 10 passes through the gate. Passage-through management state transition processor 151 also transmits, to gate 10, control information on control of gate 10 when a person who is not permitted to pass through gate 10 attempts to pass through the gate.

History manager 152 holds and manages information indicating history of persons who have passed through gate 10 (passage-through history information). History manager 152 stores the passage-through history information in history DB 153 and transmits the passage-through history information to passage-through history management server 17. By way of example, in a railway network, history manager 152 manages local passage-through history information for one station (or one ticket gate).

Passage-through history management server 17 holds and manages information indicating history of persons who have passed through gate 10 (passage-through history information). For example, passage-through history management server 17 may manage passage-through history information on a plurality of gates 10. By way of example, in a large facility having a plurality of entrances/exits, passage-through history management server 17 may manage passage-through history information on gate 10 installed in each of the entrances/exits. Also, for example, in a railway network, passage-through history management server 17 may manage passage-through history information on gates 10 of ticket gates at stations.

Meanwhile, passage-through management functional unit 15 may output information on passage-through management (passage-through management information) to a display apparatus. The passage-through management information includes, for example, the information output from face-authentication functional unit 13 and the information output from person-detection functional unit 14. The display apparatus displays a state of a person (e.g., result of face authentication for the person and moving direction). For example, the display apparatus may display a surveillance-camera image and superimpose, on the surveillance-camera image, a frame indicating a position of a person detected by the surveillance camera. Additionally, the display apparatus may superimpose, on the surveillance-camera image, information on this person (i.e., ID of the person) obtained by the face authentication.

Face-authentication functional unit 13 mentioned above may operate asynchronously to passage-through management functional unit 15. For example, face-authentication functional unit 13 may operate when a face frame is detected by camera controller 131.

The configurations of the three units as mentioned above, namely, face-authentication functional unit 13, person-detection functional unit 14, and passage-through management functional unit 15, may each be formed as one information processing apparatus (e.g., server apparatus), or two or more of the three units may be included in one information processing apparatus. For example, face-authentication functional unit 13 may be formed as one information processing apparatus, and person-detection functional unit 14 and passage-through management functional unit 15 may be included in one information processing apparatus.

The above-mentioned information processing apparatus may include a processor, a memory, and an input/output interface that is used for transmitting various kinds of information. The processor is a computing device such as a Central Processing Unit (CPU) and a Graphics Processing Unit (GPU). The memory is a memory device implemented by using a RandomAccess Memory (RAM) and a Read Only Memory (ROM). The processor, the memory, and the input/output interface are connected to a bus and exchanges various kinds of information to one another via the bus. For example, the processor reads a program, data, and the like stored in the ROM onto the RAM and executes the processing to implement the functions included in the information processing apparatus.

In person-detection functional unit 14 and passage-through management functional unit 15 as mentioned above, a region (zone) is specified for gate 10 and, based on the specified zone, the person detection and the passage-through management are performed. Next, an exemplary zone specified for gate 10 will be described.

<Gate Region Management>

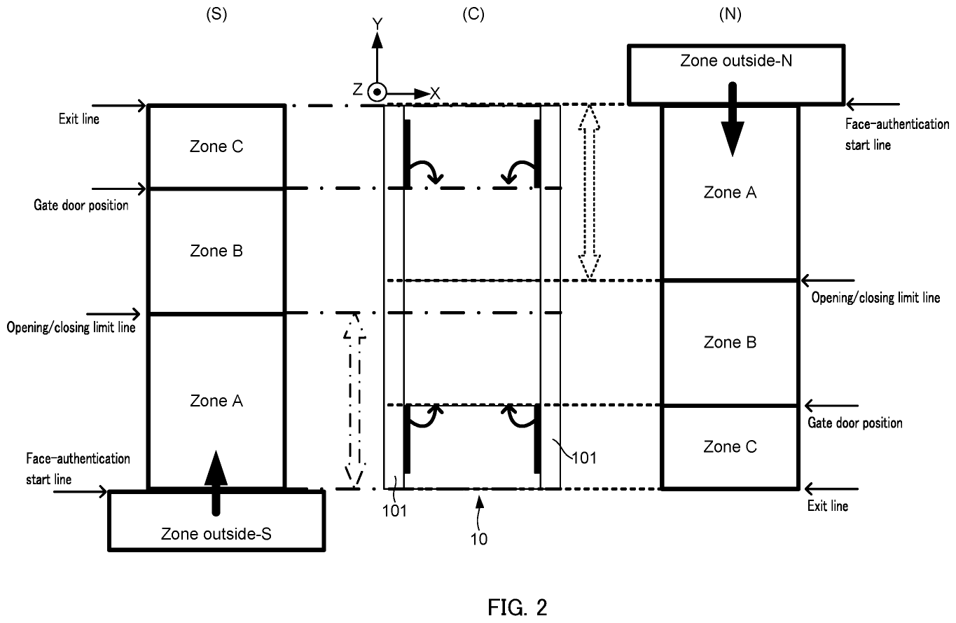

FIG. 2 illustrates exemplary zones specified for gate 10. In FIG. 2, examples of multiple regions are illustrated in a situation where gate 10 is viewed from above. Incidentally, as illustrated in (C) of FIG. 2, a passage path between side walls 101 of gate 10 is provided in the up and down direction of the sheet.

Incidentally, in FIG. 2 and in the following description, it is assumed that, when gate 10 is viewed from above, a plane is the X-Y plane and a height direction is the Z-direction. It is also assumed that a surveillance-camera image is an image of the X-Y plane and a face-capture camera image is an image of the X-Z plane.

Further, two places corresponding to end portions along the Y-axis of side walls 101 of gate 10 may be each described as an entrance/exit of gate 10. Of the two doorways of gate 10, the entrance/exit on an upstream side along a particular proceeding direction (entering direction) corresponds to an entrance, and the entrance/exit on a downstream side corresponds to an exit.

FIG. 2 illustrates, in gate 10 into which a person can proceed from both above and below, (S) that indicates zones specified when the person proceeds into from below and (N) that indicates zones specified when the person proceeds into from above.

In the example of FIG. 2, a passage path of gate 10 is provided along the up and down direction. Since an installation position of surveillance camera 12 is not particularly limited, a passage path may be present in an oblique direction or left-right direction in the surveillance-camera image. Meanwhile, in the case of bidirectional passage, it may be considered that a regulation of the proceeding direction and a regulation of a passage direction are different from each other. For example, a passage direction of a person from above to below is the normal moving direction for a person who has entered from above, whereas this passage direction is a not-normal moving direction for a person who has entered from below. For such a difference in regulations, the passage-through management function specifies the upper side as a “north side (North side)” and the lower side as a “south side (South side),” in a surveillance-camera image including a passage path in the up and down direction.

Note that the expressions such as the north side and the south side are merely exemplary, and the present disclosure is not limited to these expressions. For example, the expressions such as the north side and the south side do not limit an arrangement of gate 10 to the arrangement along the north-south direction. Further, for example, even when a passage path of gate 10 is along the left-right direction or when the passage path includes a curved line in a surveillance-camera image, one of the left and right may be specified as a “north side,” and the other may be specified as a “south side.”

A “face-authentication start line” is used for determining whether to start the face-authentication processing. For example, the face-authentication processing is started when a person crosses the “face-authentication start line” and proceeds into the gate. By way of example, a face-matching processing request is issued from the face-frame detection information, a matching result (face authentication ID) and person-detection information are linked with each other, and thus, tracking of the person is started. Note that the “face-authentication start line” may be referred to as an “A-line (ALINE).”

Incidentally, the “face-authentication start line” may be provided outside gate 10 (e.g., on upstream side along path of gate 10). Further, the “face-authentication start line” may have a plurality of line segments without being limited to a single line segment, as in a square bracket shape, for example. The shape having the plurality of line segments is not limited to a shape corresponding to some sides of a rectangular shape such as the square bracket shape and may be a shape corresponding to some sides of another polygonal shape. Alternatively, the “face-authentication start line” may have an arc or may have a shape in which straight lines and curved lines are mixed. For example, in a situation where the “face-authentication start line” has a plurality of line segments and/or an arc, the face-authentication processing is started when a person proceeds into from a side, not only from a front of gate 10.

An “opening/closing limit line” indicates a position where door-closing of a gate door on an exit side responding to an door-closing instruction can be made in time before a person passes through. For example, when a person not permitted to pass through a gate crosses the “opening/closing limit line” and moves at the highest passable speed (e.g., six km/h), the gate door on the exit side is closed before the person passes through the gate door on the exit side.

Assuming that a required time from the issuance of the door-closing instruction to the completion of the door-closing (or position recognized as door-closing) is Tc [sec] and the highest passable speed is Sm [m/sec], a length Lb [m] from the gate door to the “opening/closing limit line” may be specified in Lb=Tc×Sm.

The face-authentication processing and processing of confirming passage-through rights need completing before the person passes through the “opening/closing limits line.” The gate door is controlled such that no regulation is performed by the gate door until the person passes through the “opening/closing limit line” along a traveling direction.

Note that the “opening/closing limiting line” may be referred to as an “unauthorized-intrusion detection line” or “B line (B LINE)”.

A “gate door position” indicates a physical position of a gate door on the exit side with respect to a proceeding direction of the subject person. For example, in gate 10 with the bidirectional passage, two gate doors corresponding to the respective passage directions are provided. In one example, in the passage direction entering from the north side and exiting from the south side, the gate door on the exit side is the gate door provided on the south side of the two gate doors. In contrast, for example, in the passage direction entering from the south side and exiting from the north side, the gate door on the exit side is the gate door provided on the north side of the two gate doors.

The “gate door position” may be referred to as a “G-line (G LINE).”

An “exit line” indicates a position where the subject person is judged to have exited gate 10. The “exit line” may be provided outside gate 10, like the above-mentioned “face-authentication start line.” Further, the “exit line” may have a plurality of line segments without being limited to a single line segment, as in a square bracket shape, for example. Alternatively, the “exit line” may have an arc. Incidentally, the “exit line” may be referred to as a “Z-line (Z LINE)”, for example.

In the passage-through management, a physical position of a gate door (“gate door position”) may be only a passing-through point, and, in this case, the physical position of the gate door may be different from or identical to the “exit line” that is logically set. For example, in actual operation, the “gate door position” and the “exit line” may be set to be identical to each other.

A “zone A (Zone A)” is a region between an A-line and a B-line. The “zone A” may be referred to as an “authentication enabled area.” A “zone B (Zone B)” is a region between a B-line and a G-line. A “zone C (Zone C)” is a region between a G-line and a Z-line. Among boundaries specifying Zone C, a boundary on an upstream side along a path of gate 10 corresponds to a gate door position (G-line).

In the example of FIG. 2, Zone B is specified between Zone A and Zone C. Further, Zone C is a zone into which a person is allowed to intrude, in accordance with a result of face-authentication processing.

An “area outside a north-side zone (hereinafter may also be referred to as “north-side zone outer area”) (Zone outside-N)” is an outer area on the north side relative to the above-mentioned Zone A, as illustrated in (N) of FIG. 2. An “area outside a south-side zone (hereinafter may also be referred to as “south-side zone outer area”) (Zone outside-S)” is an outer area on the north side relative to the above-mentioned Zone A, as illustrated in (S) of FIG. 2.

Although the above has given an example in which three zones are specified except for the north-side zone outer area and the south-side zone outer area, the present disclosure is not limited to this example. The number, size, position, and shape of zones may be varied depending on a situation for which the present disclosure is applied. For example, in the case of no configuration for blocking a person from passing through, using a door such as a gate 10, Zone B may be reduced in size or may be eliminated.

Next, variations of zones specified for gate 10 will be described.

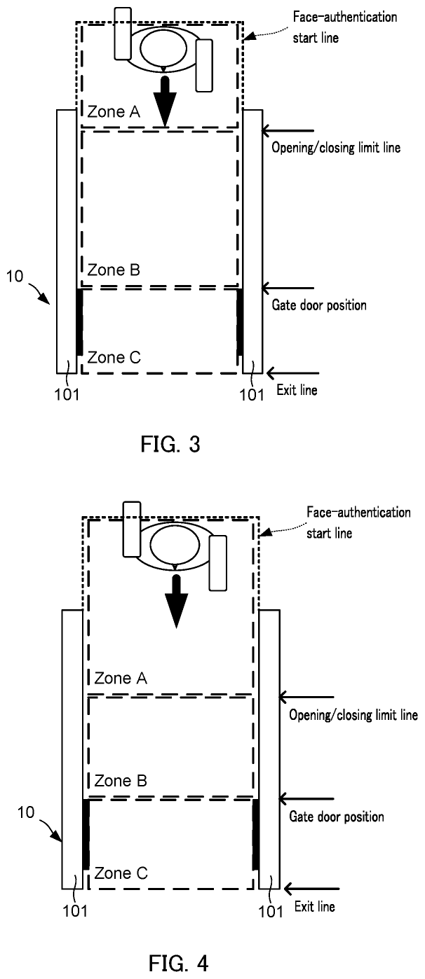

FIG. 3 illustrates Variation 1 of the zones specified for gate 10. FIG. 3 illustrates zone specifications in the case of entry from the north side. In FIG. 3, an example is illustrated in which Zone A includes a region on the upstream side (outside or north side) relative to the entrance/exit of gate 10. For example, in FIG. 3, the B-line is provided at a position of the entrance/exit on the north side. Additionally, in FIG. 3, the A-line has a square bracket shape and line segments along side walls 101 of gate 10 and a line segment perpendicular to side walls 101. Incidentally, in the case of entry from the south side, zones that are vertically symmetric with those of FIG. 3 may be specified, although not illustrated.

FIG. 4 illustrates Variation 2 of the zones specified for gate 10. FIG. 4 illustrates zone specifications in the case of entry from the north side. In FIG. 4, Zone A has a range extending from the inside to the outside (north side) of the entrance/exit of gate 10. For example, in FIG. 4, the B-line is provided between the entrance/exit on the north side and the G-line. Additionally, in FIG. 4, the A-line has a square bracket shape and line segments along side walls 101 of gate 10 and a line segment perpendicular to side walls 101, as in FIG. 3. Incidentally, in the case of entry from the south side, zones that are vertically symmetric with those of FIG. 4 may be specified, although not illustrated.

For example, the size and position of each zone may be specified by the size of gate 10, the position of a door of gate 10, the walking speed of a person passing through gate 10, and the opening/closing response speed of gate 10. The opening/closing response speed of gate 10 may be a time from when gate 10 receives the door-closing instruction to when the door of gate 10 is closed, or a time from when gate 10 receives the door-closing instruction to when the door of gate 10 is opened.

For example, the higher opening/closing response speed (response time) of gate 10 is, the smaller the size of Zone B can be. Also, the faster the assumed walking speed is, the larger the size of Zone B will be. In other words, the B-line specifying the size of Zone B is determined based on a time taken for the control on the door that restrains entry into Zone C.

Further, passage-through of a person can be blocked even when the door of gate 10 is not completely closed, and thus, for example, the zone size may be specified based on a time from when gate 10 receives the door-closing instruction to when the door of gate 10 is closed halfway (e.g., 50%). The size of Zone B with such a specification will be less than the size of Zone B specified based on the time from when gate 10 receives the door-closing instruction to when the door of gate 10 is completely closed.

For example, FIG. 3 mentioned above corresponds to the zone specified based on the time from when gate 10 receives the door-closing instruction to when the door of gate 10 is completely closed, whereas FIG. 4 corresponds to the zone specified based on the time from when gate 10 receives the door-closing instruction to when the door of gate 10 is closed halfway (e.g., 50%).

<Occurring Events>

In person-detection functional unit 14, events that occur for the detected person are judged with reference to the above-mentioned zones. The following will describe examples of the events.

Illustratively, person-detection functional unit 14 detects occurrence of four events: “person detection;” “zone movement;” “timeout;” and “disappearance (LOST).”

The “person detection” is an event that occurs when anew person is detected in the person-detection processing. In a case where the “person detection” event occurs, the subject person is given a unique ID (described as person tracking ID). In other words, the “person detection” occurs when a person who is not given a person tracking ID is detected.

The “zone movement” is an event that occurs when a zone in which a person with a person tracking ID is present at a certain time t is different from a zone in which the person was present at a time point immediately before time t (i.e., when zone changes). The “zone movement” may be movement between adjacent zones (e.g., between Zones A and B) or may be movement between non-adjacent zones (e.g., between Zones A and C). For example, occurrence of a response delay and/or a detection error in a person-detection library causes the movement between non-adjacent zones.

The “Timeout” is, for example, an event that occurs when a person remains in the same zone for a predetermined period of time or longer. A zone subject to the “timeout” is not particularly limited. Each of the specified zones may be a zone subject to the “time-out,” or a portion of the specified zones may be a zone not subject to the “time-out.” Even after the occurrence of the “timeout,” detection and tracking of the person may be continued. Meanwhile, in a case where the “timeout” occurs, a tracking management table for the person may be reset and a new tracking management table after the occurrence of the “timeout” may be assigned. Incidentally, a predetermined time to be judged as the “timeout” may be set for each zone.

The “disappearance (lost)” is an event that occurs when a person can no longer be tracked. For example, the “disappearance” occurs when a person moves outside a capturing range of a surveillance camera. Moreover, for example, the occurrence of an error in the person detection function causes the “disappearance.”

<Exemplary Control Flows>

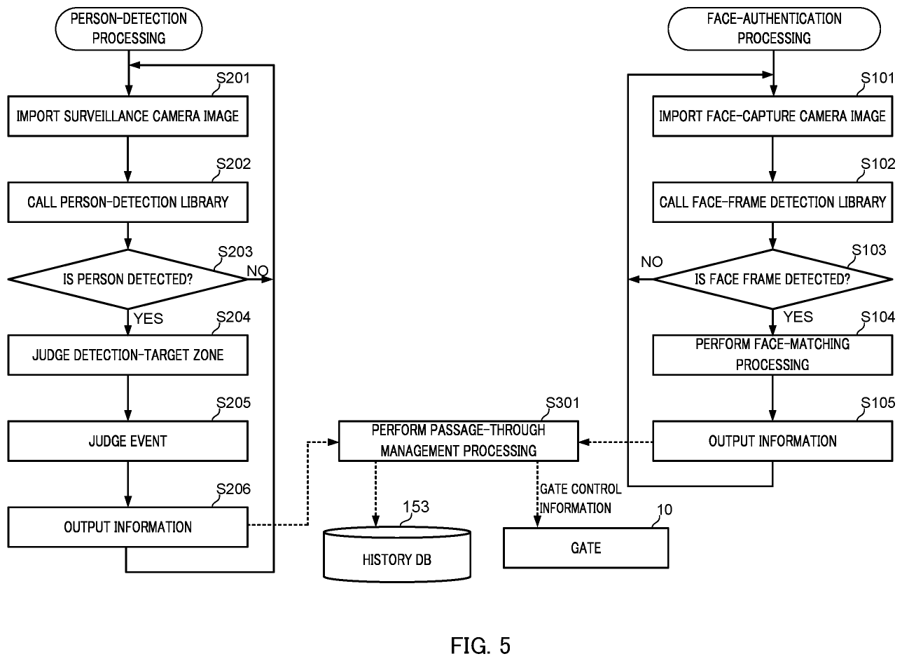

Next, control flows in passage-through management system 1 illustrated in FIG. 1A and FIG. 1B will be described. FIG. 5 is a flowchart for indicating exemplary control flows in passage-through management system 1 according to the present embodiment. FIG. 5 indicates face-authentication processing executed by face-authentication functional unit 13, person-detection processing executed by person-detection functional unit 14, and passage-through management processing executed by passage-through management functional unit 15. The respective flows will be described below.

<Face-Authentication Processing Flow>

Face-authentication functional unit 13 imports a face-capture camera image from a face capture camera (S101).

Face-authentication functional unit 13 calls a face-frame detection library (S102). The face-frame detection library is a library having a function to detect a face of a person included in an image. A face frame is, for example, a rectangular frame surrounding an area of the face (face region) of the person included in the image. For example, face-authentication functional unit 13 calls the face-frame detection library to detect whether the imported face-capture camera image includes a face region, and when the face region is detected, outputs information on the face frame surrounding the detected face region (face-frame detection information). The face-frame detection information includes position coordinates of four points indicating the face frame (e.g., X-coordinates and Z-coordinates in X-Z plane) and the size of face frame (e.g., width in X-axis direction and/or width in Z-axis direction in X-Z plane). Note that the shape of the face frame is an example and may be a shape other than a rectangle, such as a circle or a polygon.

Face-authentication functional unit 13 executes face-frame detection in the face-capture camera image and judges whether the face frame has been detected (S103). For example, face-authentication functional unit 13 performs this judgement based on whether the face-frame detection information is output from the face-frame detection library.

In a case where the face frame is not detected (NO in S103), the flow returns to S101. For example, the case of no face-frame detection corresponds to a case where a face is not included in the face-capture camera image or a case where the face frame fails to be detected from the face-capture camera image that includes the face.

In a case where the face frame is detected (YES in S103), face-authentication functional unit 13 performs face-matching processing (face-authentication processing) (S104). Face-authentication functional unit 13 extracts, from the face-capture camera image, the face region in the detected face frame and transmits the face region to face authentication server 16. Face authentication server 16 judges whether a face of the same person as the face in the extracted face region is included in face images registered in face authentication server 16 (registered face images). In a case where the face of the same person as the extracted face region is included in the registered face images, face authentication server 16 judges that the face authentication has been successful, and in a case where the face is not included, the face authentication server judges that the face authentication has failed.

Face-authentication functional unit 13 indicates, to passage-through management functional unit 15, face-image processing information that includes a matching processing result indicating whether the face authentication is successful and information on coordinates of the detected face frame (S105). The flow then returns to S101 and a face-capture camera image in the next capture timing is imported.

<Person-Detection Processing Flow>

Person-detection functional unit 14 imports a surveillance-camera image from a surveillance camera (S201).

Person-detection functional unit 14 calls a person-detection library (S202). The person-detection library is a library having a function to detect a person included in an image. For example, person-detection functional unit 14 calls the person-detection library and then inputs the imported surveillance-camera image into the person-detection library. The person-detection library detects whether a person is included in the surveillance-camera image, and in a case where the person is detected, outputs information indicating a position of the detected person (person-detection information). The person-detection information includes position coordinates of the person (e.g., X-coordinate and Y-coordinate in X-Y plane) and the size of person (e.g., width in X-axis direction and/or width in Y-axis direction in X-Y plane). The coordinates indicating the position of the person may be a position of a center of the person detected in the surveillance-camera image or may be one or more corner positions of four corners of a rectangular frame surrounding a range of the person. Note that the person-detection library need not output the size of person (e.g., width in X-axis direction and/or width in Y-axis direction in X-Y plane). Further, the frame surrounding the range of the person is not limited to a rectangular and may have a shape other than a rectangle, such as a circle or a polygon.

Person-detection functional unit 14 judges whether a person is detected in the surveillance-camera image (S203). For example, person-detection functional unit 14 performs this judgement based on whether the person-detection information is output from the person-detection library.

In a case where the person is not detected (NO in S203), the flow returns to S201. For example, the case of no person detection corresponds to a case where a person is not included in the surveillance-camera image or a case where the person fails to be detected from the surveillance-camera image that includes the person.

In a case where a person is detected (YES in S203), person-detection functional unit 14 judges a detected zone (detection-target zone) among zones specified for gate 10 (S204). For example, in the surveillance-camera image, a center of the range of the detected person is specified as a representative point, and a zone including the representative point corresponds to the detected zone. Alternatively, in the surveillance-camera image, based on the degree of overlap between the range of the detected person and the zones, a zone with the highest proportion of the range of the person corresponds to the detected zone. In one example, in the surveillance-camera image, when Zone A includes 60% of the range of the detected person and Zone B includes 40% thereof, person-detection functional unit 14 judges that the detected zone is Zone A. In such a manner, it is possible to reduce the possibility of erroneous judgement that a person in the vicinity of a boundary of zones has moved between zones. Meanwhile, a zone including the front end of the range of the detected person in a traveling direction may be regarded as the zone in which the person has been detected. Here, for example, as illustrated in (S) of FIG. 2, in a case where the positive direction of the Y-axis is the traveling direction, the front end of the range of the detected person in the traveling direction may correspond to a position with the largest Y-coordinate among coordinates indicating the range of the detected person. In such a manner, it is possible to quickly detect that the person has entered the zone. In contrast, a zone including the rear end of the range of the detected person in the traveling direction may be regarded as the zone in which the person has been detected. In such a manner, it is possible to reduce the possibility of erroneous judgement for the zone including the person.

Person-detection functional unit 14 judges an event for the detected person (S205). For example, with reference to a processing result in S204 for a surveillance-camera image imported in at least one time point before the current point, person-detection functional unit 14 judges which of the above-mentioned events of “person detection,” “zone movement,” “timeout,” and “disappearance” has occurred. Incidentally, when none of the above four events is applicable, person-detection functional unit 14 may judge there is no event. For example, in a case where the detected person remains in a particular zone without moving, but does not remains until a time corresponding to the “time-out,” it may be judged that no event has occurred.

Person-detection functional unit 14 indicates, to passage-through management functional unit 15, information including the result judged in S205 (person-tracking event information) (S206). The person-tracking event information may include an ID of the detected person, a detection time, a position (e.g., coordinates) of the detected person, information on the zone judged in S204, and information on the event judged in S205.

The flow then returns to S201, and the next person-detection processing may be performed. The person-detection processing in person-detection functional unit 14 may be executed at, for example, each time when surveillance camera 12 performs capturing and outputs a surveillance-camera image.

Incidentally, the person-detection processing and the face-authentication processing as described above may be executed independently of each other, or may be executed in synchronization with each other. For example, one of the person-detection processing and the face-authentication processing may be executed with a result of the other as a trigger. By way of example, the face-authentication processing may be started with detection of entry of a person into Zone A in the person-detection processing as a trigger. In the manner described above, a target for the face authentication can be narrowed down because the face-authentication processing is performed on a person who is detected to have proceeded into Zone A, which is the person likely to pass through gate 10, and a person who does not proceed into Zone A is excluded from the face-authentication processing, which results in shortening a time required for the entire face authentication. Alternatively, the person-detection processing may be started with detection of a face frame in the face-authentication processing as a trigger, regardless of whether a person has proceeded into Zone A. In such a manner, the face-authentication processing can be performed in advance (e.g., prior to detection of entry into Zone A of person), so that the face-authentication processing can be completed at an earlier timing. Additionally, in this case, the person-detection processing can be executed in parallel because there is no need to wait for a result of the person-detection processing, such as the detection of the entry into Zone A.

<Passage-Through Management Processing>

Passage-through management functional unit 15 manages states of persons around gate 10 based on the information output from face-authentication functional unit 13 and the information output from person-detection functional unit 14 (S301). For example, when the person-tracking event information indicates entry into an authentication enabled area (Zone A) of the person for which the person-tracking event information has been detected, passage-through management functional unit 15 performs processing of associating pieces of information with each other (face-linking processing), with reference to the face-image processing information.

For example, passage-through management functional unit 15 associates the pieces of information based on a position and a detection time of a person included in the person-tracking event information and a position and a detection time of a face frame included in the face-image processing information. In one example, when a difference between coordinates (X, Y) indicating the position of the person on one hand and X coordinates indicating the position of the face frame and Y coordinates estimated from the size of face frame on the other hand is equal to or less than a predetermined value, it is judged that the person indicated by the person-tracking event information and the person of the face indicated by the face-image processing information are identical to each other. Alternatively, when the difference between the detection time in the person-tracking event information and the detection time in the face-image processing information is equal to or less than a predetermined value, it is judged that the person indicated by the person-tracking event information and the person of the face indicated by the face-image processing information are identical to each other. Meanwhile, the judgement for a position and the judgement for a time may be combined.

The person-tracking event information and the face-image processing information that have been judged of the same person are linked with each other.

In a case where the linking can be performed, passage-through management functional unit 15 judges that the passage of the person corresponding to the linked information is permitted. By contrast, in a case where the linking cannot be performed, passage-through management functional unit 15 judges that the passage of the person corresponding to the person-tracking event information is not permitted. When permitting the passage of the person, passage-through management functional unit 15 outputs, to gate 10, gate-control information including a door-opening instruction. When not permitting the passage of the person, passage-through management functional unit 15 outputs, to gate 10, gate-control information including a door-closing instruction.

Incidentally, regardless of whether the linking is successful or not, passage-through management functional unit 15 may output, to gate 10, the gate-control information including the door-closing instruction or gate-control information including a warning instruction, based on the person-tracking event information. Passage-through management functional unit 15 may make the door-closing instruction and/or the warning instruction when, for example, the person-tracking event information indicates abnormality of a state (or behavior) of a person. For example, when the person remains in Zone A or Zone B of gate 10 for a predetermined time or longer (i.e., when “time-out” event occurs in Zone A or Zone B), the warning instruction may be made for issuing a warning that prompts the person to move. This is because such a person is assumed to be standing still in the gate. Also, when a person remains in Zone C of gate 10 for a predetermined time or longer (i.e., when “time-out” event occurs in Zone C), the warning instruction may be made for issuing a warning that prompts the person to move. This is because such a person is assumed to be standing still immediately after passing through the gate. Gate 10 may output a voice prompting the person to move, display character information, or turn on a warning light or the like on the basis of the warning instruction. Further, the situation where the person remains in the gate may be indicated to an administrator of gate 10 (e.g., station staff in the case of gate installed in station) on the basis of the warning instruction.

<Tracking-Management Table>

The above-described person-tracking event information may be managed in a table format, for example. The table for managing the person-tracking event information may be referred to as a tracking-management table. Hereinafter, a description of the tracking-management table will be given.

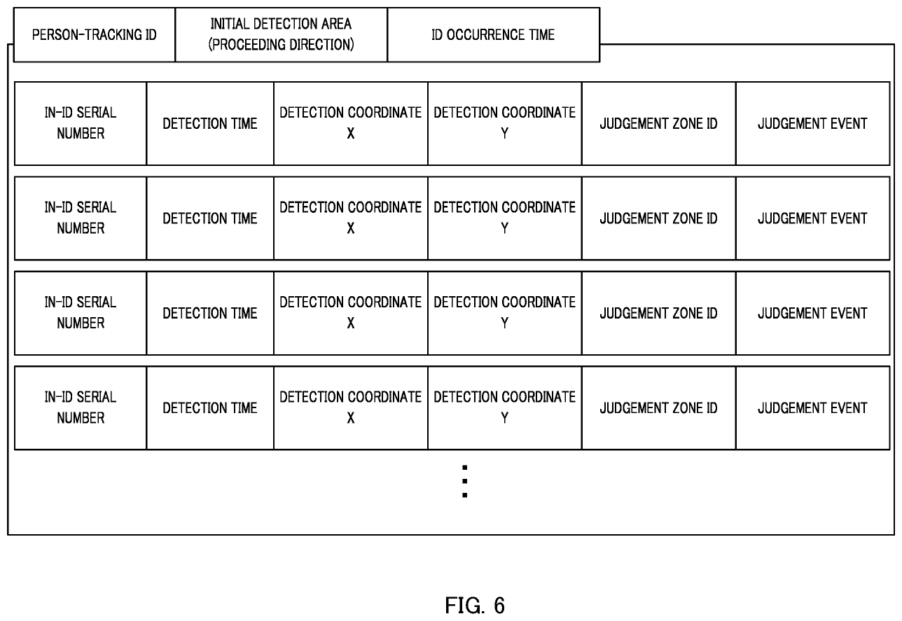

FIG. 6 illustrates an exemplary tracking-management table. For example, when the person-detection library detects a new person in person-detection functional unit 14, the detected person is given an ID (person tracking ID). Then, a tracking management table is allocated (assigned) to the person to which the person tracking ID has been given.

As illustrated in FIG. 6, the tracking management table manages detection times of the person to which the person tracking ID has been given, position coordinates of the detected person (detection coordinates X and detection coordinates Y), detected zones (judgement zone IDs), and events that have occurred (judgement events).

Hereinafter, one row in FIG. 6 may be described as a “record.” The record is registered for each detection time, for example.

For example, position coordinates of a person detected in certain detection time t is compared with the specified zones to judge the zone in which the person has been detected in detection time t, and a judgement zone ID is thus registered.

By comparing the zone judgement result in detection time t with the judgement zone ID of the record in the tracking management table at a time point immediately before time t, it is judged whether a zone-movement event has occurred. When the zone-movement event occurs, information indicating the zone movement is registered as the judgement event. For example, in the case where no event has occurred, “no event” is registered.

When a person with a person tracking ID disappears, information indicating the disappearance is registered as the judgement event. Then, information on the tracking-management table for the person tracking ID is output to the log file.

<Person-Tracking Event>

Information on each event mentioned above may be represented by a sequence of the predetermined number of characters. For example, the sequence of the predetermined number of characters may be referred to as an event ID.

The event IDs exemplified below distinguish and manage the events for each proceeding direction of a person, in gate 10 through which the bidirectional passage-through is possible.

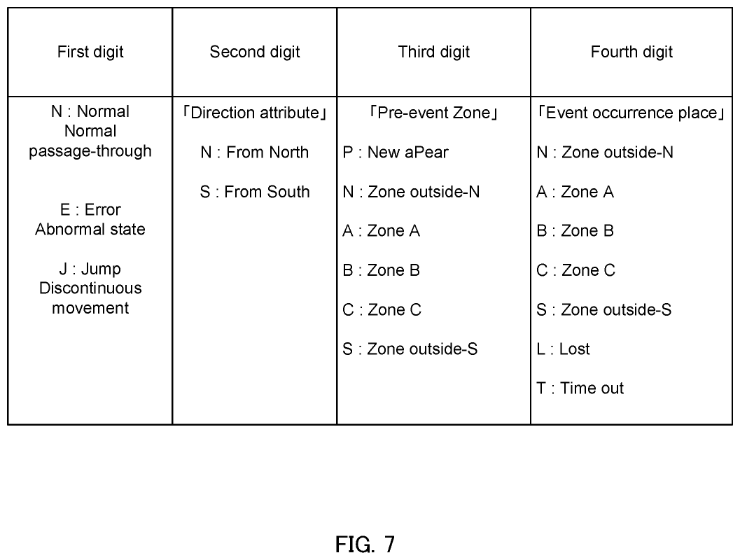

FIG. 7 illustrates definition examples of event IDs. The event IDs illustrated in FIG. 7 are each represented by a four-digit character string, as an example.

A character of the first digit represents the type of event. In the first digit, one of the characters “N,” “E,” and “J” is set. “N” denotes normal passage-through, “E” denotes an abnormal state (error), and “J” denotes discontinuous (jumping) movement. The discontinuous movement corresponds to, for example, movement between non-adjacent zones.

The second digit represents the attribute of a person for an entering direction. In the second digit, either the character “N” that denotes entering from the north side or “S” that denotes entering from the south side is set.

A character of the third digit represents a zone where a person stayed before an event occurs. In the third digit, one of the characters “P,” “N,” “A,” “B,” “C,” and “S” is set. “P” denotes new appearance, in other words, that no detection has been made in any of zones before the event occurs. “N” denotes a north-side zone outside area (“out-of-zone North”). “A,” “B,” and “C” denote Zone A, Zone B, and Zone C, respectively. “S” denotes a south-side zone outside area (“out-of-zone South”).

A character of the fourth digit represents a zone where an event has occurred. In the fourth digit, any of the characters “N,” “A,” “B,” “C,” “S,” “L,” and “T” is set. “N,” “A,” “B,” “C,” and “S” are the same as in the third digit. “L” denotes occurrence of disappearance (lost), in other words, the person is not detected in any of the zones. “T” denotes the timeout.

A description will be given of an example of person-tracking event based on the above-described event IDs.

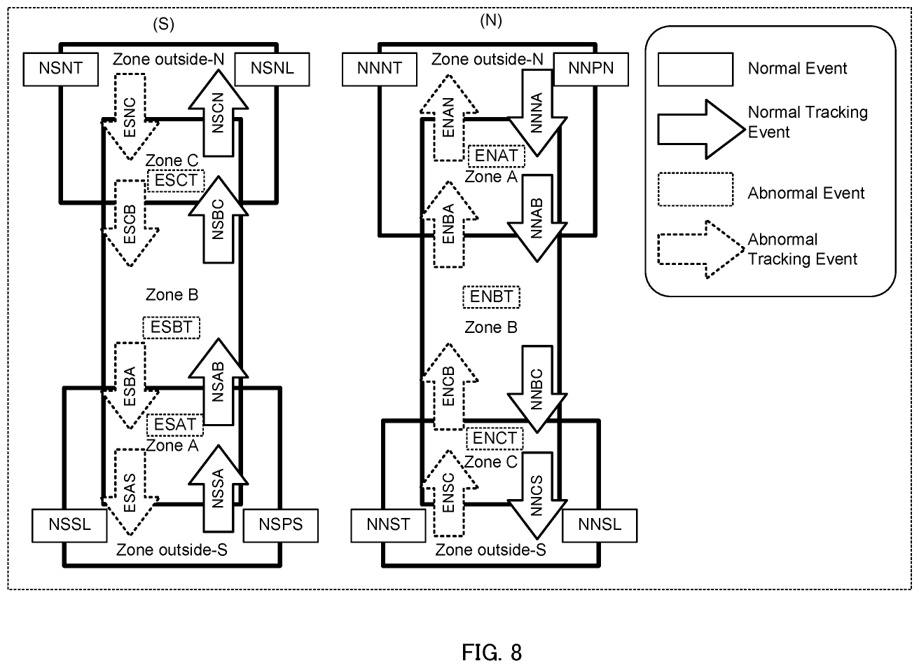

FIG. 8 illustrates a first example of the person-tracking event. Illustratively, in (S) of FIG. 8, exemplary event IDs in the case of tracking a person who proceeds into from the south side for gate 10 are illustrated, in association with zone-to-zone movement in gate 10. In the example in (S) of FIG. 8, the second digit is set to “S” because the person has proceeded into from the south side.

By way of example, “NSPS” denotes an event that a person who proceeds into from the south side is newly detected in the south-side zone outside area (“person detection”).

“NSSL” denotes an event that a person who proceeded into from the south side and stayed in the south-side zone outside area has disappeared (“lost”). For example, this event occurs when this person leaves the south-side zone outside area without passing through gate 10.

For example, each arrow with the first digit “N” is an ID given to an event of zone movement when a person who has proceeded into from the south side moves to an adjacent zone. In one example, “NSAB” denotes the event that a person who proceeded into from the south side and stayed in Zone A prior to the event occurrence has moved to Zone B (“zone movement”).

For example, “NSNL” denotes an event that a person who proceeded into from the south side and stayed in the north-side zone outside area has disappeared (“lost”). “NSNT” denotes an event of time-out of a person who proceeded into from the south side and remained in the north-side zone outside area (“timeout”).

For example, “ESCT,” “ESBT,” and “ESAT” denote timeout events for persons stayed in Zone C, Zone B, and Zone A, respectively.

For example, each arrow with the first digit “E” is an ID given to an event of zone movement when a person who has proceeded into from the south side travels in the reverse direction to the direction of passage-through from the south side to the north side. In one example, “ESBA” denotes an event that a person who proceeded into from the south side and stayed in Zone B prior to the event occurrence has moved to Zone A (“zone movement”).

Illustratively, in (N) of FIG. 8, exemplary event IDs in the case of tracking a person who proceeds into from the north side for gate 10 are illustrated, in association with zone-to-zone movement in gate 10. In the example of FIG. 8, the second digit is set to “N” because the person has proceeded into from the south side. Although the example in (N) of FIG. 8 is different from the example in (S) of FIG. 8 in the specifications of a proceeding direction of a person and the zones based on the proceeding direction, the descriptions of the event IDs are the same detailed descriptions of which will be thus omitted.

Next, lists of candidates for event IDs will be described.

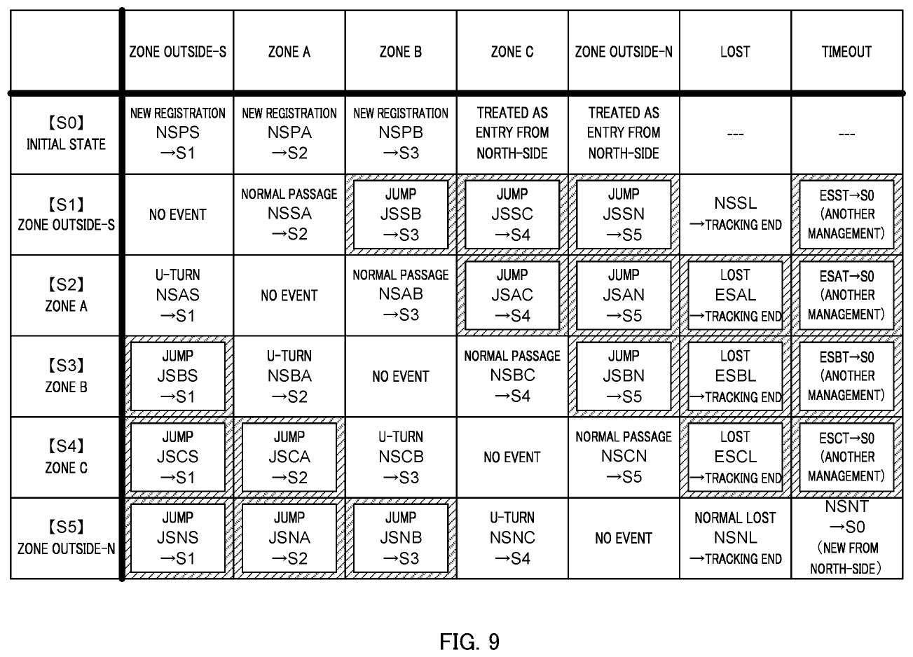

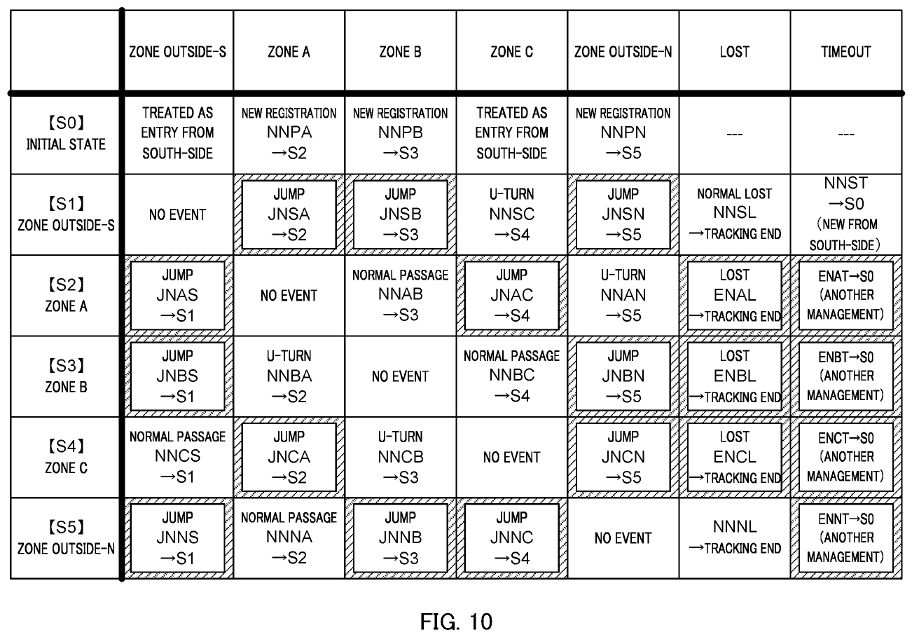

FIG. 9 illustrates a list of candidates for event IDs of a person who has proceeded into from the south side. FIG. 10 illustrates a list of candidates for event IDs of a person who has proceeded into from the north side. Each of rows in FIGS. 9 and 10 corresponds to a state prior to the event occurrence (hereinafter may also be referred to as “pre-event state”), and each of columns in FIGS. 9 and 10 corresponds to a zone in which a person has been detected. FIGS. 9 and 10 illustrate, in a table format, pre-event states, event IDs corresponding to zones in which a person has been detected, and state transitions. Among the event IDs, transitions different from a normal state transition are marked with shaded frames.

Six pre-event states of “S0” to “S5” are specified in FIGS. 9 and 10.

“S0” indicates an initial state. “S1” to “S5” indicate states in which the zone prior to the event occurrence is a south-side zone outside area, Zone A, Zone B, Zone C, and a north-side zone outside area, respectively.

For example, in “S0” of FIG. 9, when a new person is detected in the south-side zone outside area, Zone A, or Zone B, it is determined that the event of “person detection” occurs of a case where the person has proceeded into from the south side. Then, the detected person is given a person ID and is newly registered. For example, in this case, a tracking-management table for the detected person is newly assigned.

On the other hand, in “S0” of FIG. 9, when a new person is detected in Zone C or the north-side zone outside area, the person is treated as having proceeded into from the north side.

For example, in “S0” of FIG. 10, when a new person is detected in the north-side zone outside area, Zone A, or Zone B, it is determined that the event of “person detection” occurs of a case where the person has proceeded into from the north side. Then, the detected person is given a person ID and is newly registered. For example, in this case, a tracking-management table for the detected person is newly assigned.

On the other hand, in “S0” of FIG. 10, when a new person is detected in Zone C or the south-side zone outside area, the person is treated as having proceeded into from the south side.

In other words, in an initial state, a proceeding direction of a person to be detected is not determined. Therefore, in the initial state, the proceeding direction of the person is determined in accordance with a position of the detected person, and an event ID based on the determined proceeding direction is determined.

Further, as illustrated in FIGS. 9 and 10, when the “disappearance (lost)” occurs in “S2” to “S4,” i.e., when a person to whom a person ID has been given can no longer be detected, for example, the tracking of the person is ended.

Further, as illustrated in FIGS. 9 and 10, when the “time-out” occurs in “S1” to “S5,” i.e., when a person to whom a person ID has been given remains in the same zone, for example, another tracking management table for the person may be separately assigned and the tracking management may be continued with the new tracking management table.

Next, descriptions will be given of use cases to be managed in the above-mentioned passage-through management. Note that the exemplary use cases below are each an example of passage-through management of a person who proceeds into from the north side.

<Use Case 1>

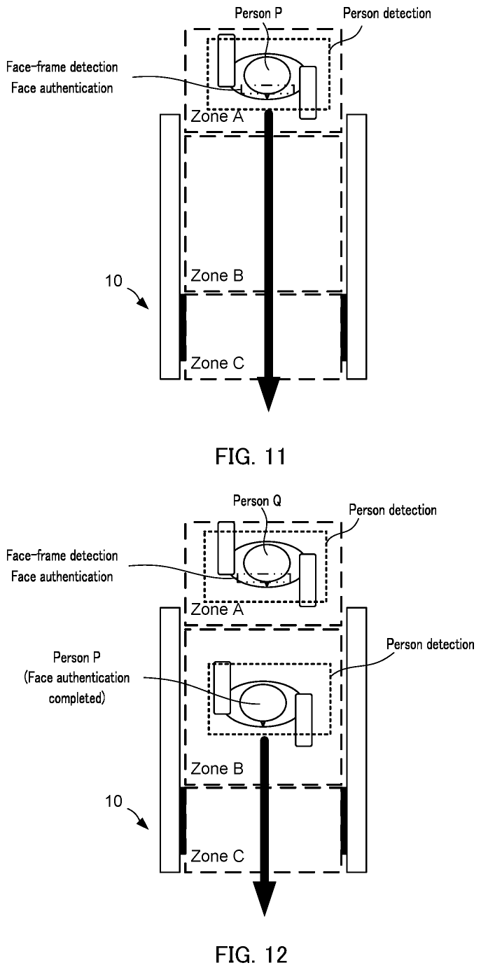

FIG. 11 illustrates an example of Use Case 1. FIG. 11 illustrates an example of normal passage-through from the north side. Incidentally, person P in FIG. 11 has the rights to pass through a gate (hereinafter, referred to as “passage rights”) and his/her face image is registered in face authentication server 16. In this case, person P is detected in the “north-side zone outside area” located outer relative to Zone A (i.e., “person detection” event occurs). Then, in Zone A, a face frame of person P is detected, and the face-authentication processing is executed. In the face-authentication processing, person P is judged to have the passage rights. Accordingly, the door-opening instruction is indicated to the gate.

When movement of person P from Zone A to Zone B is detected (“zone movement” event), control for permitting the passage through gate 10 is executed. For example, in a case where gate 10 is in a door-closed state, control for opening the door of gate 10 is executed.

Movement of person P from Zone B to Zone C and movement of person P from Zone C to the south-side zone outside area are detected (“zone movements”); thereafter, the presence of person P in the specified zones including the south-side zone outside area is no longer detected, and thus, the disappearance of person P is judged (“lost”).

Note that even when person P has the passage rights, the control for permitting the passage through gate 10 need not be executed while person P is in Zone A. This avoids performing control on gate 10 to open the door in a case where person P proceeds into Zone A by chance without planning to pass through gate 10, for example.

<Use Case 2>

FIG. 12 illustrates an example of Use Case 2. Use case 2 of FIG. 12 is a case where a plurality of persons passes through in succession. In this case, the plurality of persons is included in at least a surveillance-camera image.

Person P and Person Q have the passage rights and their face images are registered in face authentication server 16.

When a plurality of persons passes through in succession, the tracking management is performed on each of the persons. Moreover, in the person-detection library, person-detection information on the plurality of persons is output from one surveillance-camera image. Person-detection functional unit 14 assigns a tracking management table for each of the plurality of persons.

Then, normal passage-through of person P and normal passage of person Q are independently managed. Management of the normal passage-through may be the same as that in Use Case 1. Note that in this case, complement processing using a photoelectric sensor may be performed.

<Use Case 3>

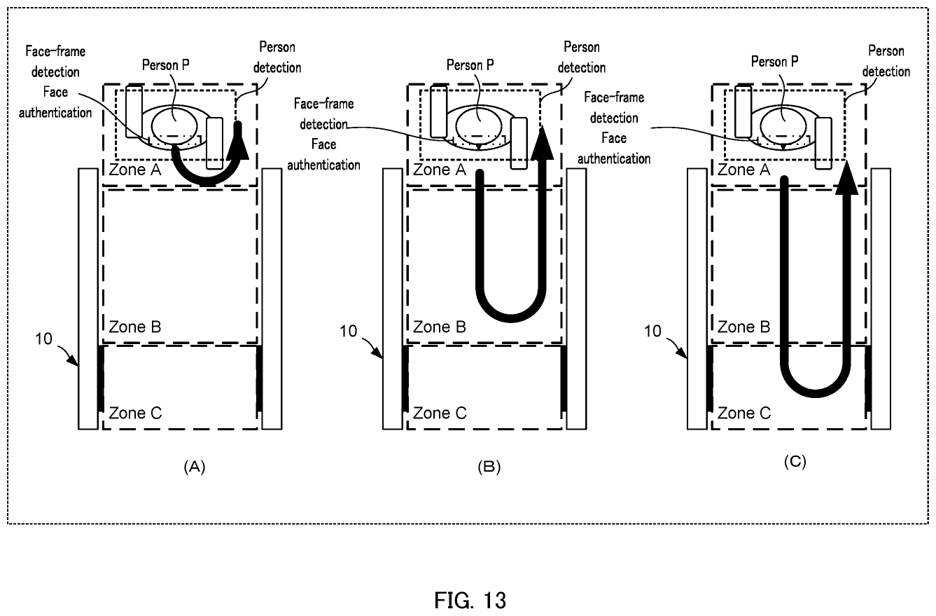

FIG. 13 illustrates an example of Use Case 3. Use Case 3 of FIG. 13 is a case of making a U-turn in the middle of the gate instead of going out from the exit of gate 10.

For example, in the example in (A) of FIG. 13, person P makes a U-turn in Zone A. In this case, after the detection of movement of person P from Zone A to the north-side zone outside area, the presence of this person in the specified zones including the north-side zone outside area is no longer detected, and thus, the disappearance of person P is judged.

Further, for example, in the example in (B) of FIG. 13, person P makes a U-turn in Zone B. In this case, movement of person P from Zone A to Zone B, movement from Zone B to Zone A, and movement from Zone A to the north-side zone outside area are detected. Then, the presence of person P in the specified zones is no longer detected, and thus, the disappearance of person P is judged.

Further, for example, in the example in (C) of FIG. 13, person P makes a U-turn in Zone C. In this case, it is detected that person P has moved from Zone A to Zone B, Zone C, Zone B, Zone A, and the north-side zone outside area in this order. Then, the presence of person P in the specified zones is no longer detected, and thus, the disappearance of the person is judged.

<Use Case 4>

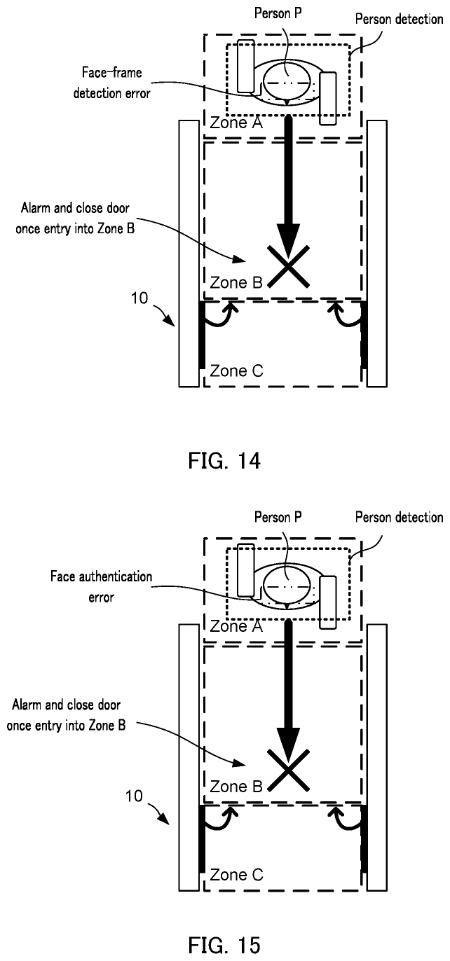

FIG. 14 illustrates an example of Use Case 4. Use case 4 of FIG. 14 is a case where an error occurs in the face-frame detection.

In this situation, the detection of a face frame of person P fails in Zone A. When the face-frame detection fails, the face-authentication processing is not executed and whether person P has the passage rights cannot be judged. Therefore, the door-closing instruction is indicated to gate 10 in this case. Then, when movement of person P from Zone A to Zone B is detected, the door-closing control for blocking the passage through gate 10 is executed. Note that in this case, gate 10 may be instructed to issue an alert.

Even when whether person P has the passage rights cannot be judged, the control for blocking the passage through gate 10 need not be executed while person P is in Zone A. This avoids performing control on gate 10 to close the door in a case where person P proceeds into Zone A by chance without planning to pass through gate 10, for example.

Incidentally, the case of failure in the face-frame detection may be a case where no face-frame detection information is output from the face-frame detection library. Alternatively, the case of failure in the face-frame detection may be a case where a difference between a position of the face-frame indicated by the output face-frame detection information and a position of the person indicated by the person-detection information may be equal to or larger than a predetermined value.

<Use Case 5>

FIG. 15 illustrates an example of Use Case 5. Use Case 5 of FIG. 15 is a case where an error occurs in the face-authentication processing.

In this case, although a face frame of person P is detected in Zone A, the face authentication fails. The failure of the face authentication includes, for example, a case where a face image of person P is not registered in face authentication server 16 and a case where an authentication score between the registered face image of person P and a face region indicated by the detected face frame are equal to or less than a threshold. In this situation, person P is judged not to have the passage rights. Then, when movement of person P from Zone A to Zone B is detected, the door-closing control for blocking the passage through gate 10 is executed, as in Use Case 4.

Incidentally, even when person P has no passage rights, the door-closing control for blocking the passage through gate 10 need not be executed while person P is in Zone A. This avoids performing control on gate 10 to close the door in a case where person P proceeds into Zone A by chance without planning to pass through gate 10, for example.

<Use Case 6>

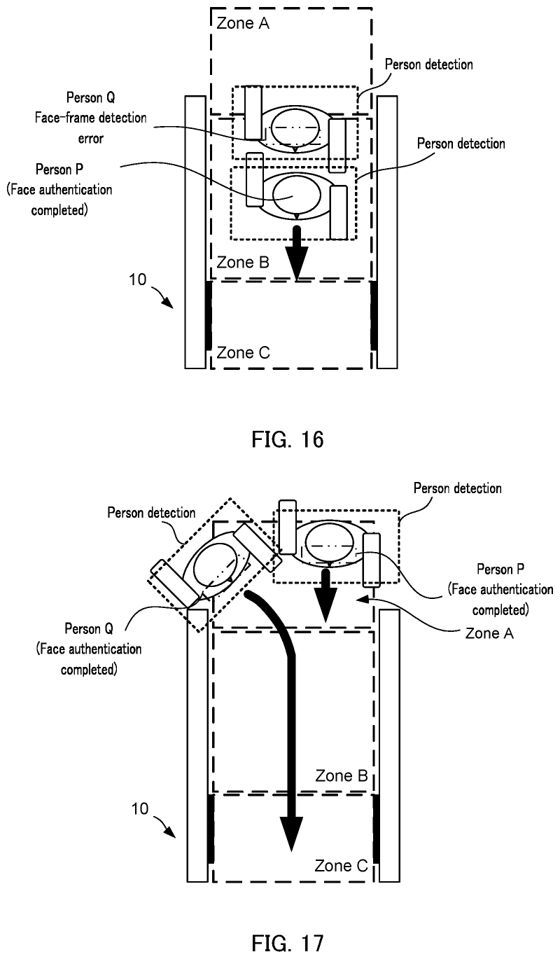

FIG. 16 illustrates an example of Use Case 6. Use Case 6 of FIG. 16 is a case where a plurality of persons passes through gate 10 collectively (tailgating act). In this case, at least a surveillance-camera image includes the plurality of persons, whereas a face-capture camera image includes one face because the plurality of persons overlaps with each other.

Illustratively, person P and person Q are included in the surveillance camera image, and the face of person P is included in the face-capture camera image while the face of person Q is not included therein. Additionally, in this example, person P has the passage rights while person Q has no passage rights.

In this situation, since the face of person Q is not included in the face-capture camera image, a face frame of person Q is not detected, and thus, whether person Q has the passage rights cannot be judged.

In this case, since whether person Q has the passage rights cannot be judged although person P has the passage rights, the control for blocking the passage through gate 10 may be executed when person Q has moved to Zone B. In such a case, it may be judged that the “tailgating” has occurred.

Moreover, in this case, when the door-closing control is executed to block passing gate 10 at the timing when person Q has moved to Zone B, person P may collide with the gate door, depending on a distance between person P and person Q. Therefore, information indicating that the “tailgating” by person Q has occurred may be stored in association with the surveillance camera image and the face-capture camera image, and the passage through gate 10 of person Q may not be blocked. In this situation, person Q may pass through gate 10 while whether person Q has the passage rights remains unknown. For example, when the destination after passing through gate 10 is a closed space, it is possible to charge person Q a fee for the passage rights, by confirming the presence or absence of the passage rights or the “tailgating” at the time of exiting.

Whether to perform the control for blocking the passage through gate 10 may be changed, depending on a positional relation between person P and person Q. For example, when person P has already moved to Zone C, the control for blocking the passage-through may be performed since there is no danger to person P, and when person P still remains in Zone B, the passage-through may not be blocked. Further, when the tailgating is detected while person P is present in Zone B, the control for blocking the passage-through may be performed after the timing at which person P moves to Zone C. Meanwhile, taking into account the movement speed of person P, when it is predictable that person P will move to Zone C before the gate door is closed, the control for blocking the passage-through may be started even in a situation where both person P and person Q are present in Zone B.

<Use Case 7>

FIG. 17 illustrates an example of Use Case 7. Use Case 7 of FIG. 17 is a case where person Q having the passage rights for gate 10 cuts in while person P having the passage rights for gate 10 are passing.

For example, in this case, once person P proceeds into Zone A, the face-frame detection and the face-authentication processing for person P are executed. Then, it is judged that person P has the passage rights, and the door-opening instruction for the control to permit the passage of person P through gate 10 is issued.

In FIG. 17, before person P moves to Zone B, person Q proceeds into Zone A and moves from Zone A to Zone B. In this situation, once person Q proceeds into Zone A, the face-frame detection and the face-authentication processing for person Q are executed. Since person Q has the passage rights, the door-opening instruction that permits person Q to pass through gate 10 is then issued. Meanwhile, the door-opening instruction issued because person P has been judged to have the passage rights is canceled. For example, in this situation, the door-opening instruction that permits person P to pass through gate 10 may be issued by person P moving to Zone A and the face-authentication processing being re-executed.

Incidentally, the door-opening instruction issued because person P has been judged to have the passage rights may not be canceled.

<Use Case 8>

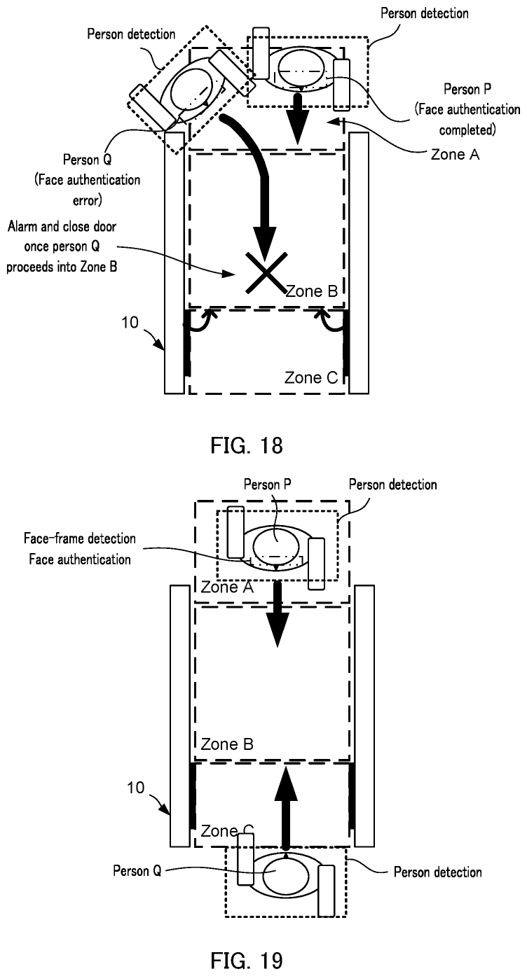

FIG. 18 illustrates an example of Use Case 8. Use Case 8 of FIG. 18 is a case where person Q not having the passage rights for gate 10 cuts in while person P having the passage rights for gate 10 are passing.

For example, in this case, once person P proceeds into Zone A, the face-frame detection and the face-authentication processing for person P are executed. Then, it is judged that person P has the passage rights, and the door-opening instruction for the control to permit the passage of person P through gate 10 is issued.

In FIG. 18, before person P moves to Zone B, person Q proceeds into Zone A and moves from Zone A to Zone B. In this situation, once person Q proceeds into Zone A, the face-frame detection and the face-authentication processing for person Q are executed. Since person Q has no passage rights, the door-closing instruction that blocks the passage of person Q through gate 10 is then issued. Meanwhile, the door-opening instruction issued because person P has been judged to have the passage rights is canceled. For example, in this situation, the door-opening instruction that permits person P to pass through gate 10 may be issued by person P moving to Zone A and the face-authentication processing being re-executed.

<Use Case 9>

FIG. 19 illustrates an example of Use Case 9. Use Case 9 of FIG. 19 is a case of appearance of persons who proceed into from both directions of gate 10. In this case, the zone-specification applied to the person-detection for person P is different from the zone-specification applied to the person-detection for person Q.

For example, when it is detected that person P has proceeded into Zone A from the north side and that person Q has proceeded into Zone A from the south side, the face-frame detection and the face-authentication processing are executed for person P and person Q. Then, between person P and person Q, the person for whom the face-authentication succeeds first is permitted to pass. By way of example, when the face authentication for person P succeeds ahead of that for person Q, the door-opening instruction is issued to permit the passage of person P who has proceeded into from the north side. In this case, control for blocking the passage of person Q who has proceeded into from the south side may be executed (e.g., output of display of no-entry and/or warning sound). In this situation, however, the door-closing is not included in the control for blocking the passage of person Q who has proceeded into from the south side.

<Use Case 10>

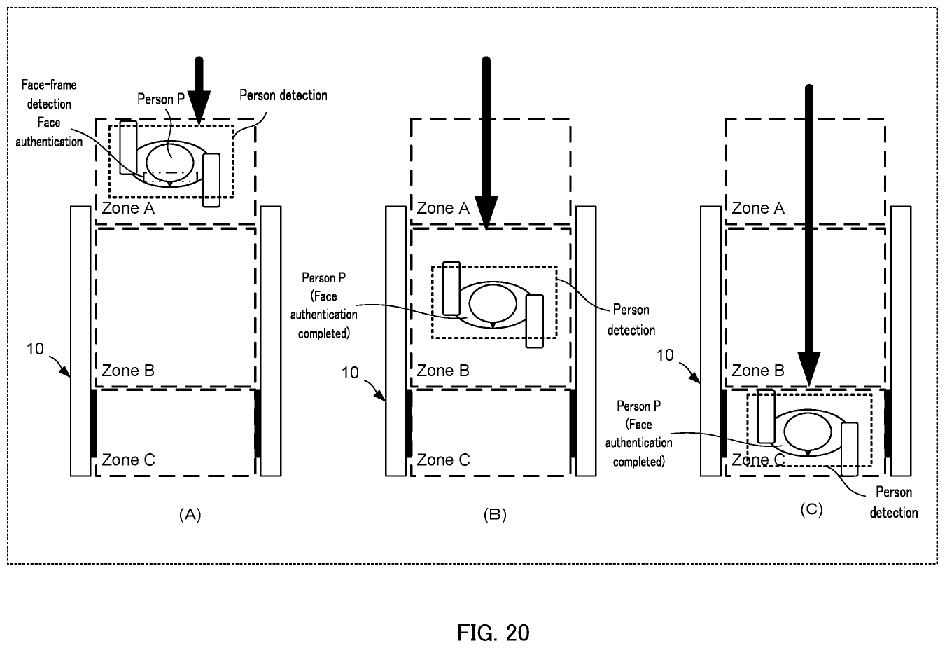

FIG. 20 illustrates an example of Use Case 10. Use Case 10 of FIG. 20 is a case where a person stays in a certain zone for a long period of time.

As illustrated in (A) of FIG. 20, when person P having the passage rights stays in zone A for a long period of time, the timeout of person P occurs in Zone A. In this case, when person P has the passage rights, the door-opening instruction has been issued and the door is in an open-waiting state, but the open-waiting state may be canceled with the occurrence of the timeout as a trigger.

As illustrated in (B) of FIG. 20, when person P having the passage rights stays in zone B for a long period of time, the timeout of person P occurs in Zone B. In this case, under a door-opened state, the control for prompting person P to pass through gate 10 may be executed (e.g., output of character display or voice prompting passage-through). Alternatively, in this case, the door-opened state may be canceled to transit a door-closed state, and control for prompting person P to again pass through the gate may be executed (e.g., output of character display or voice prompting U-turn).

As illustrated in (C) of FIG. 20, when person P having the passage rights stays in zone C for a long period of time, the timeout of person P occurs in Zone C. In this case, under a door-closed state, control for prompting person P to pass through gate 10 may be executed (e.g., output of character display or voice prompting passage).

<Use Case 11>

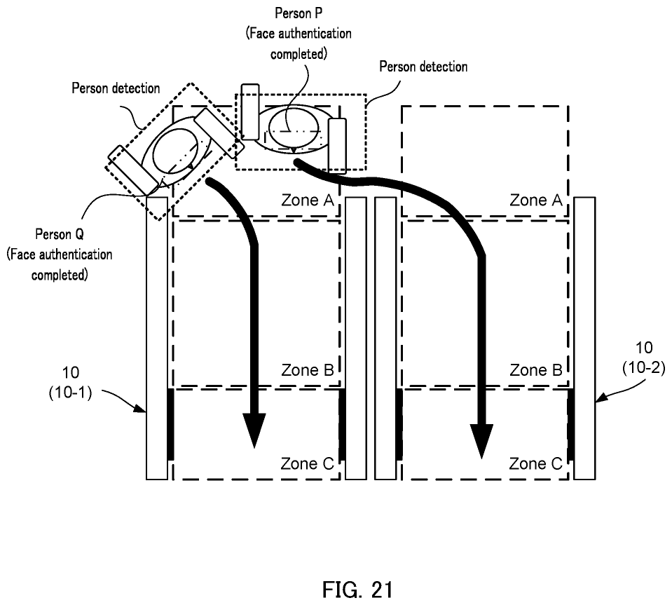

FIG. 21 illustrates an example of Use Case 11. Use Case 11 of FIG. 21 is a case where person Q cuts in and proceeds into gate 10-1 sideways while person P attempting to pass through gate 10-1, and person P then lets person Q pass through gate 10-1 and slides to proceed into gate 10-2.

Incidentally, in the example of FIG. 21, the zones specified for gate 10-1 and the zones specified for gate 10-2 may overlap. For example, the north-side zone outside area for gate 10-1 may overlap the north-side zone outside area for gate 10-2 and/or Zone A for gate 10-2. This reduces the possibility of losing track of person P because person P who has slid and proceeded into is more likely to be in the north-side zone outside area and/or Zone A of gate 10-1 or gate 10-2.

For example, in this case, once person P proceeds into Zone A of gate 10-1, the face-frame detection and the face-authentication processing for person P are executed. Then, it is judged that person P has the passage rights, and the door-opening instruction for the control to permit the passage of person P through gate 10-1 is issued.

In FIG. 21, before person P moves to Zone B of gate 10-1, person Q proceeds into Zone A of gate 10-1 and moves to Zone B of gate 10-1. In this situation, once person Q proceeds into Zone A of gate 10-1, the face-frame detection and the face-authentication processing for person Q are executed. Since person Q has the passage rights, the door-opening instruction that permits person Q to pass through gate 10-1 is then issued. Meanwhile, the door-opening instruction issued because person P has been judged to have the passage rights is canceled.

Then, in FIG. 21, once person P proceeds into Zone A of gate 10-2 from Zone A of gate 10-1, the face-frame detection and the face-authentication processing for person P are executed. Then, it is judged that person P has the passage rights, and the door-opening instruction that permits person P to pass through gate 10-2 is issued.

As described above, in the present embodiment, tracking of a person heading from Zone A to Zone C starts before he/she moves to Zone A. When it is detected that the person has moved to Zone A (authentication enabled area), the person is tracked by associating a result of the face-authentication processing for the person with a tracking result for the person, thereby managing entry of the person into Zone C. Thus, the processing for passage-through management including detection processing (tracking processing) on the person can be started from a position located farther than an entrance of gate 10 (e.g., position farther than Zone A), which makes it possible to prevent the tracking-processing result from being lost and improve the accuracy of tracking management.

In addition, associating the person-detection result with the face-authentication result makes it possible to grasp in real time who is where and when, and which route he/she is traveling. Hence, an abnormal state of a person (e.g., U-turn or jump), or an unauthorized act of a person (e.g., tailgating) can be detected.

Moreover, for example, in a case where the face authentication is started with the entry into Zone A as a trigger, the number of targets for the face authentication can be reduced, and thus, the accuracy of the face-authentication processing can be improved.

Further, a zone for gate 10 can be specified outward relative to an entrance of gate 10; hence, a flexible zone can be specified regardless of the size of gate 10 and the flexibility of the passage-through management can also be improved.

In the above-described embodiment, a system for managing passage-through of a person who passes through gate 10 has been described, but the present disclosure is not limited to this. For example, the present disclosure may be applied to a case of no gate 10, in other words, side walls of a passage path and a regulator (e.g., door) that regulates the passage-through of a person are absent. In this case, for example, the present disclosure may be applied as long as the case includes a traveling path heading from a certain zone to another zone where entry of a person is allowed in accordance with authentication processing. In this case, the size of Zone B may be reduced, or Zone B itself may be eliminated.

Additionally, in the present embodiment, an example has been given in which an authentication target is a person, but the present disclosure is not limited to this example. For example, the present disclosure may be applied to a case where an authentication target is a moving object such as an animal, a vehicle, or the like. Also, although the present embodiment has given an example of performing the face authentication, but the present disclosure is not limited to this. For example, the present disclosure may be applied to other authentication methods such as authentication with an ID card that indicates possession of passage rights for a gate, biological authentication, and the like.

Further, the face authentication and other authentication methods may be used in combination. Even when the passage-through is not permitted by the face authentication according to the disclosure of the above-described embodiment, the passage-through may be exceptionally permitted with ID-card information input.

Further, in the above-described embodiment, a door has been used as a means for regulating the passage through gate 10, but the passage-through may be directly or indirectly regulated by other means. For example, an alarm may be sounded or a warning light may be turned on to indicate, to a person who is about to pass gate 10, that the passage through gate 10 has been regulated. Further, an indication may be transmitted to a terminal or the like in the possession of a staff around gate 10 in order to have the staff to regulate the passage-through. In these cases, the length of Zone B may be set based on a time required for each regulation. Specifically, the length of Zone B may be set based on the time required for the processing of issuing the alarm, the time required for turning on the warning light, or the time until the indication is delivered to the terminal.

Meanwhile, depending on the congestion condition, whether to perform control for blocking the passage-through or a means for regulating the passage-through may be switched. For example, in an environment where it is dangerous to block or regulate the passage-through of a person, such as when a large number of people enter and exit, the passage through gate 10 may not be blocked, whereas information indicating the occurrence of unauthorized passage-through may be recorded. In such a case, a face image or a result of the face authentication for a person who has performed the unauthorized passage-through may be recorded in association with the information indicating the occurrence of the unauthorized passage-through. This makes it possible to track the person who has performed the unauthorized passage-through later and to charge a fee for the passage rights.

Further, in the embodiment described above, passage-through management system 1 has managed both entering and exiting an entrance/exit of a facility such as an airport, a station, an event venue, or the like, but, in an entrance or an exit, one of the entering or the exiting the facility may be managed while the other may not be managed. In this case, the capturing area of surveillance camera 12 may be limited to a direction in which a person proceeding into gate 10 appears or may be set to monitor this direction widely. Thus, tracking of a person who is about to pass through gate 10 can be started earlier.

The present disclosure can be realized by software, hardware, or software in cooperation with hardware.

Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include an RF (radio frequency) module including amplifiers, RF modulators/demodulators and the like, and one or more antennas. Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT).”

In addition, in recent years, in Internet of Things (IoT) technology, Cyber Physical Systems (CPS), which is a new concept of creating new added value by information collaboration between physical space and cyberspace, has been attracting attention. Also in the above embodiment, this CPS concept can be adopted.

That is, as a basic configuration of the CPS, for example, an edge server disposed in the physical space and a cloud server disposed in the cyberspace can be connected via a network, and processing can be distributedly performed by processors mounted on both of the servers. Here, it is preferable that processed data generated in the edge server or the cloud server be generated on a standardized platform, and by using such a standardized platform, it is possible to improve efficiency in building a system including various sensor groups and/or IoT application software.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as, a base station, an access point, and any other apparatus, device or system that communicates with or controls apparatuses such as those in the above non-limiting examples.

The embodiment has been described with reference to the drawings hereinabove. Obviously, the present disclosure is not limited to this example. Obviously, a person skilled in the art would arrive variations and modification examples within a scope described in claims, and it is understood that these variations and modifications are within the technical scope of the present disclosure. Moreover, any combination of features of the above-mentioned embodiment may be made without departing from the spirit of the disclosure.

While concrete examples of the present invention have been described in detail above, those examples are mere examples and do not limit the scope of the appended claims. The techniques disclosed in the scope of the appended claims include various modifications and variations of the concrete examples exemplified above.

The disclosure of Japanese Patent Application No. 2020-202624, filed on Dec. 7, 2020, including the specification, drawings and abstract is incorporated herein by reference in its entirety.

### INDUSTRIAL APPLICABILITY

One exemplary embodiment of the present disclosure is suitable for face authentication systems.

### REFERENCE SIGNS LIST

1 Passage-through management system
10 Gate
101 Side wall
11 Face capture camera
12 Surveillance camera
13 Face-authentication functional unit
131 Camera controller
132 Face-matching processor
14 Person-detection functional unit
141 Person-tracking processor
15 Passage-through management functional unit
151 Passage-through management state transition processor
152 History manager
153 History DB
16 Face authentication server
17 Passage-through history management server

1. An information processing apparatus, comprising:
a tracker that tracks an authentication target heading from a first region to a second region into which entry is allowed in accordance with a result of authentication processing, the tracker being configured to start tracking the authentication target before the authentication target moves to the first region;
an authenticator that performs the authentication processing on an authentication target situated in the first region; and
a processor that manages entry of the authentication target into the second region by tracking the authentication target while associating a result of the authentication processing for the authentication target and a tracking result for the authentication target when the tracker detects that the authentication target has moved to the first region.

2. The information processing apparatus according to claim 1, wherein:
a traveling path from the first region to the second region includes a passage path of a gate apparatus, and
the first region includes a region on an upstream side relative to an entrance of the gate apparatus along the traveling path.

3. The information processing apparatus according to claim 2, wherein:
a boundary on an upstream side of the first region along the traveling path is specified by a start line on which the authentication processing is started, and
the authenticator performs the authentication processing on an authentication target for which the tracker has detected entry of the authentication target into the first region.

4. The information processing apparatus according to claim 2, wherein the authenticator detects an authentication target for which the authentication processing is executable, and performs the authentication processing regardless of whether the detected authentication target is situated on an upstream side relative to the first region.

5. The information processing apparatus according to claim 2, wherein:
the gate apparatus allows bidirectional entering, and
the first region and the second region are specified in respective entering directions.

6. The information processing apparatus according to claim 2, wherein:
the gate apparatus includes a regulator that regulates entry into the second region, and
a boundary on an upstream side of the second region along the traveling path is specified at a position of the regulator.

7. The information processing apparatus according to claim 6, wherein:
a third region is specified between the first region and the second region,
a boundary between the first region and the third region is determined based on a time taken for control by the regulator, and
the processor controls the regulator such that regulation based on an authentication result associated with the authentication target is not executed until the authentication target situated in the first region moves to the third region.

8. The information processing apparatus according to claim 1, wherein the authentication processing is face-authentication processing based on a face image of the authentication target.

9. The information processing apparatus according to claim 8, wherein the tracker tracks the authentication target by using an image captured from a position and/or an angle different those or that for the face image.

10. An information processing system, comprising:
an authentication apparatus that performs authentication processing on an authentication target situated in a first region; and
an information processing apparatus that includes a tracker and a processor, the tracker tracking the authentication target heading from a first region to a second region into which entry is allowed in accordance with a result of the authentication processing, the tracker being configured to start tracking the authentication target before the authentication target moves to the first region, the processor managing entry of the authentication target into the second region by tracking the authentication target while associating a result of the authentication processing for the authentication target and a tracking result for the authentication target when the tracker detects that the authentication target has moved to the first region.

11. A passage-through management method, comprising:
tracking, by an information processing apparatus, an authentication target heading from a first region to a second region into which entry is allowed in accordance with a result of authentication processing, the tracker being configured to start tracking the authentication target before the authentication target moves to the first region;
performing, by the information processing apparatus, the authentication processing on an authentication target situated in the first region; and
managing, by the information processing apparatus, entry of the authentication target into the second region by tracking the authentication target while associating a result of the authentication processing for the authentication target and a tracking result for the authentication target when it is detected that the authentication target has moved to the first region.
